(19) United States
(12) Patent Application Publication
(10) Pub. No.: US 2014/0129042 A1
(43) Pub. Date: May 8, 2014

(54) Community Based Energy Management System

(71) Applicant: Dorazio Enterprises, Inc., San Antonio, TX (US)

(72) Inventor: John Miner, Helotes, TX (US)

(21) Appl. No.: 13/927,494

(22) Filed: Jun. 26, 2013

Related U.S. Application Data
(60) Provisional application No. 61/723,556, filed on Nov. 7, 2012.

(51) Int. Cl. G05B 13/02

(52) U.S. Cl. CPC G05B 13/02
USPC 700/296; 700/295

(57) ABSTRACT

An energy management system for a localized community serviceable by a power equivalent of no more than about 100 MW of electrical energy. The system and techniques thereof are directed at managing allocations of total available energy generated at the localized community as between current use and storage. Further, the management of the energy is enhance through a variety of optimizations (e.g. optimizers) that may be applied to a variety of different, polygenerating energy-types available to the community.

### PRIORITY CLAIM/CROSS REFERENCE TO RELATED APPLICATION(S)

This Patent Document claims priority under 35 U.S.C. §119 to U.S. Provisional App. Ser. No. 61/723,556, filed on Nov. 7, 2012, and entitled, “System and Method for a Smart Micro-grid Polygeneration System Providing Community Energy Surety and the Economic Dispatching of Electrical Power to the Bulk Grid”, which is incorporated herein by reference in its entirety.

### BACKGROUND

Meeting energy demands for a growing population is becoming an increasingly challenging endeavor. Whether country to country or on a worldwide-basis, as industrialized populations increase, so too does demand for energy. Once more, meeting demand may present challenges apart from merely increasing energy supplies. For example, effective and efficient management of availably energy resources alone has become an increasingly sophisticated process.

Conventional grid operations directed at managing electric power distribution to a metropolitan area are an example of the current level of sophistication involved today's energy management systems. Specifically, in an effort to help ensure reliability of available energy to a given population, such a grid may be managed in light of certain accumulated and forecasting data. For example, a grid operator may have available historical data regarding past usage for a given service area and/or weather reports that may be accounted for in determining likely near-term energy requirements. Use of such data may help the operator to optimize and distribute energy output over the service area in order to meet demands.

Efforts to optimize data for sake of energy management may become fairly complex. For example, the service area is likely to cover up to a million or more different customers and associated historical data points. Once more, with improved technology such data is becoming larger and more real-time in nature as opposed to just historical. Similarly, from a total data standpoint, the total energy needs themselves are likely to be met in an overlapping fashion. That is, separate natural and liquid petroleum gas, electrical power, and other dedicated energy-provider systems may be utilized in meeting the utility needs of the same service area.

The degree of optimization which may be achieved by the operator through use of the massive amount of data noted above is significantly limited. More specifically, such a large amount of variable data renders any algorithm for total management of the energy supply impractical and largely unreliable. Nevertheless, the grid operator may take some advantage of the available data. For example, reviewed in snapshot fashion, the data may provide a day or two of relatively reliable lead time in terms of managing energy needs of the service area.

Unfortunately, ‘reliability’ as noted above is relative term. That is, consistency of service to customers in the service area is likely to include periods of managed short term brown-outs when energy supply is estimated to be deficient. Alternatively, where the day or two lead time estimates point to a considerable surplus for the service area, energy may be sold or reallocated to another service area.

This vacillating state of affairs, between brown-outs and sell-offs, of even the most reliable energy management systems, is even more noteworthy when considering the underlying energy supply itself. For example, due to energy management limitations, a conventional coal-fired electric power plant is likely to vent off the majority of its thermal energy to the biosphere, never reaching potential customers in the first place. Yet, in addition to the increased data management capabilities that would be required to address such an issue, the grid itself is physically limited. That is, today's grid infrastructure is such that utility-scale energy storage is an exception rather than the rule. Rather, electric power is generally consumed well within a second after being produced. Accordingly, so as to meet reliability standards, grid operators regularly exercise high output protocols that eventually result in scheduled blackouts.

Further considering such large-scale power plants, critical issues beyond inherent inefficiencies emerge. For example, security breaches ranging from copper wire thieves to terrorist actions at even a single location may disrupt service to an ever increasing number of people as the population of the service area continues to grow. Once more, reliance on a smaller number of centralized power plants leads to a more massive scale in terms of the plant itself, associated equipment and the high-voltage lines involved. Accordingly, the plant and such large-scale components may present their own increased safety and health-related hazards to the nearby population.

Ultimately, potential beneficial opportunities, in terms of economy of scale are largely lost in the area of energy management. That is, an increasing amount of customer data, energy supply options, and large-scale power plants may provide certain benefits. However, these benefits are of diminishing value, and may even be detrimental in certain situations. For example, at some point the management of massive amounts of customer demand data becomes impractical in terms of increasing optimization beyond a day or two of lead time for forecasting energy requirements, of often intermittent reliability. Furthermore, health and security-related drawbacks may inherently accompany such larger scale energy management efforts.

### SUMMARY

Methods of managing energy distribution are detailed herein. The distribution techniques are directed at a localized community and include acquiring real-time community-based data relative to multiple energy types that are available to the community. Further, managing the allocation of the total available energy from the energy types may be engaged based on the noted data. Indeed, a portion of the total available energy may also be stored for sake of delayed distribution. Once more, for embodiments detailed herein, the localized community may be one whose power requirements are substantially met by no more than about 100 megawatts of electrical power or other suitable equivalent or combination.

### BRIEF DESCRIPTION OF THE DRAWINGS

FIG. 1 is a schematic representation of an embodiment of a network-based energy management system for a localized community.

FIG. 2 is an overview schematic of the localized community with energy hardware infrastructure interfacing the management system of FIG. 1.

FIG. 3A is a graph depicting a typical energy demand cycle as applied to the localized community of FIG. 2 when operating off of the grid.

FIG. 3B is a contrasting graph depicting the demand cycle of FIG. 3A but reflecting the micro-grid optimization available through embodiments of community based energy management techniques of embodiments detailed herein.

FIG. 4 is a flow-chart summarizing an embodiment of utilizing a community-based energy management system.

### DETAILED DESCRIPTION

Embodiments are described herein with reference to certain types of localized communities for which a variety of different energy types may be managed and/or transferred outside of the community. More specifically, safety, security, reliability, sustainability and costs may be enhanced through use of management techniques detailed herein. In particular, embodiments are discussed as applied to localized residential and metropolitan communities. However, other types of communities such as a college or university campus, office complex, amusement park, resort complex, military installation, hospital complex, manufacturing complex, industrial ecopark, prison locales and others may be serviced through techniques and hardware detailed herein. Regardless, the embodiments described herein are particularly directed at localized communities of discrete energy requirements for which total energy may be distributively optimized and stored.

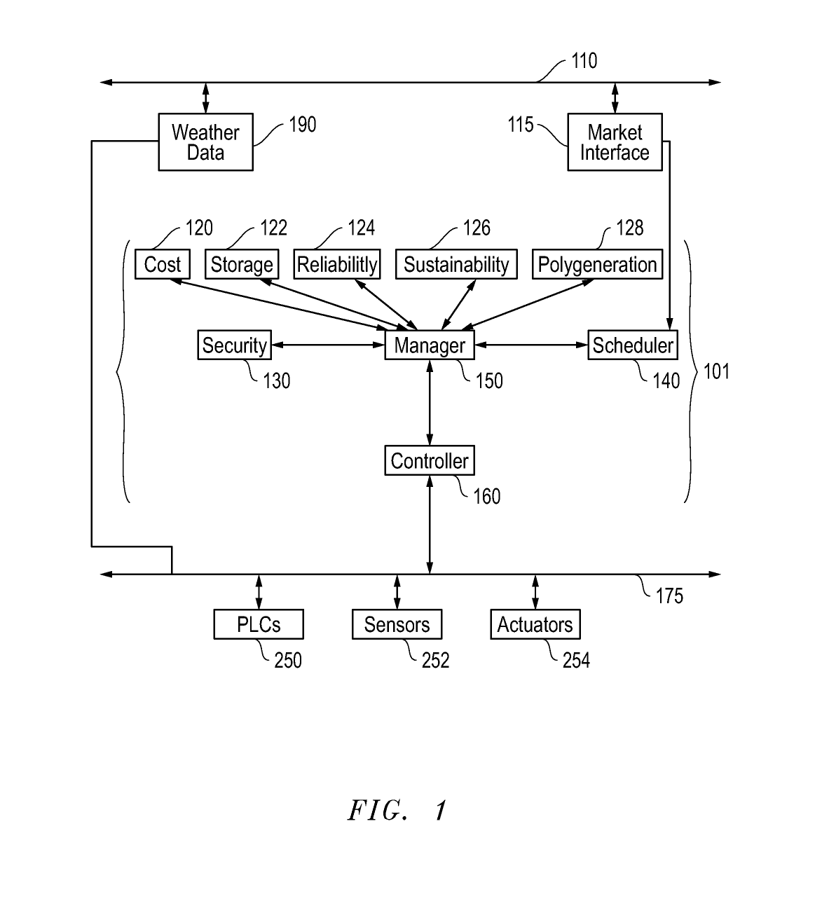

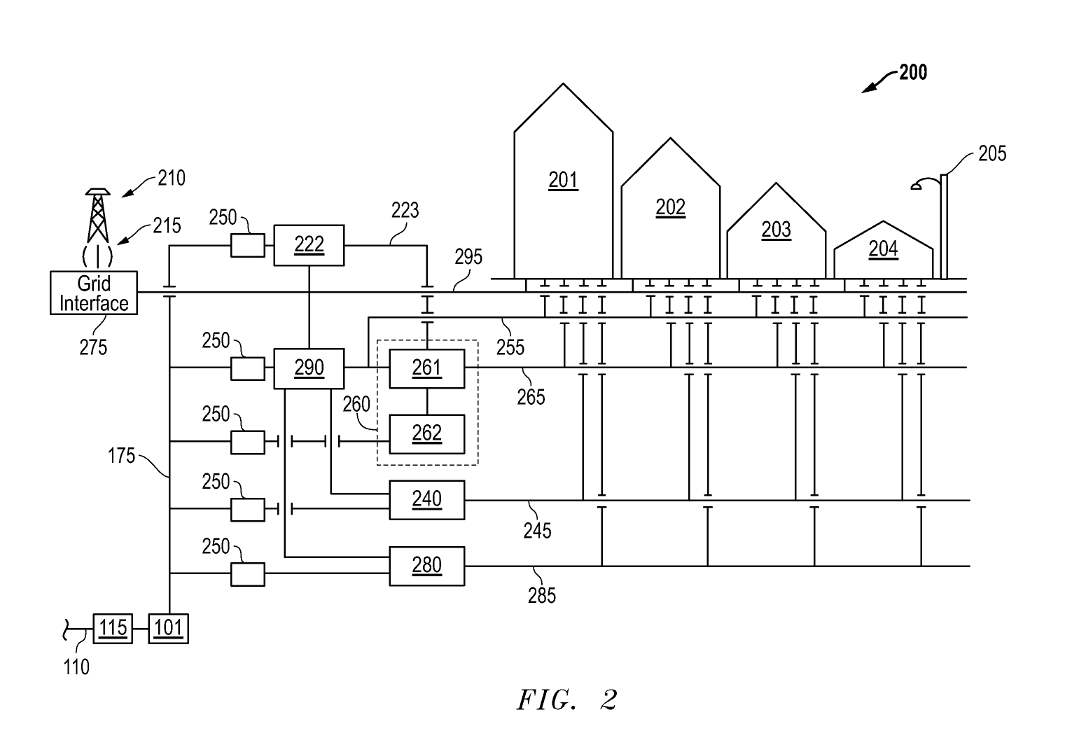

Referring now to FIG. 1, with some added reference to FIG. 2, a schematic representation of a management system 101 is depicted. The system 101 may be network-based for application to a micro-grid arrangement as detailed further below. More specifically, a micro-grid power management arrangement may be utilized for governing power needs of a localized community 200. A localized community 200 is defined herein as a community serviceable by a power equivalent of under about 100 megawatts (MW) of electrical power. That is, regardless of the particular power types utilized, the community is small enough that such a power capacity of the micro-grid should be more than adequate for meeting power requirements at any given point in time. By modern US standards, with electric power consumption approaching upwards of 1,500 Watts/person, the localized community 200 is likely well below 25 thousand combined residential, commercial and industrial customers.

With such a community 200 in mind, the energy management system 101 may be geared toward a variety of optimizers 120, 122, 124, 126, 128 and in a closed-loop fashion. That is, while external factors such as weather data 190 may become relevant, the system 101 is configured to focus on the energy management of a specific localized community 200. More specifically, in the embodiment shown, the network-based system 101 may exchange energy related data with the community 200 across a standard local area network 175. Such real-time energy usage and other related information may be processed through a total energy manager 150, which in turn interacts with the noted optimizers 120, 122, 124, 126, 128 that may be of a fuzzy-logic envelop-controller variety. The multivariable control strategy used by the manager 150 may chain or sequence the individual optimizers 120, 122, 124, 126, 128 to constrain the process within a safe operating envelop while the overall optimization proceeds. This may be done in order to simplify the total energy manager's 150 data management and computational analysis. Thus, in addition to localized community data, added steps may be taken to ensure practicality for overall management by the system 101.

The manager 150 in the depicted embodiment is also in communication with a security monitor 130 and scheduler 140 such that real-time, adaptive constraints may be added, removed or changed in priority. More specifically, the security monitor 130 may be utilized to indentify and relay breaches in cyber or physical security. Such may be detected by any sudden or atypical changes in demand at the grid level, micro-grid level or perhaps even all the way down to the customer level. Along these lines, the security monitor 130 may also be in communication with weather data 190 from an external network 110 (e.g. the interne°. Thus, the manager 150 may be alerted of anticipated demand changes due to historical or predictive weather events. In terms of the scheduler 140, pending transmission requests, preventative maintenance actions, and supply-chain requirements may be relayed to the manager 150, which will also perform exception management.

Continuing with reference to FIG. 1, with added reference to FIG. 2, the community focused optimizers 120, 122, 124, 126, 128 relate to a variety of predetermined or dynamic protocols with an emphasis on energy surety. For example, a cost optimizer 120 may be programmed to optimize in terms of the amount of transmission sales to lower the overall energy cost for the community 200. A storage optimizer 122 may constrain the system 101 in terms of electrical energy, thermal energy, carbon dioxide output or other storage management for the community 200 (e.g. on a rolling 24 hour, demand/need basis). A reliability optimizer 124 may constrain the system 101 in terms of overall supply and demand. A sustainability optimizer 126 may constrain the system 101 in terms of environmental goals and/or regulatory requirements associated with waste feedstock limitations. Lastly, in the embodiment depicted, a polygeneration optimizer 128 may constrain the system 101 by optimizing the mix of electrical power, thermal energy (steam, heat, hot water, etc.), synthetic gas (syngas), carbon dioxide, and/or perhaps other community-required polygeneration resources. This may again be on a rolling 24 hour, demand/need basis.

While the noted optimizers 120, 122, 124, 126, 128 may be of particular benefit for such a grid type of system, additional preprogrammed and/or reprogrammable optimizers may be utilized. Once more, the ability to fully and effectively utilize such constraining and regulating optimizer features of the system 101, is rendered practical by managing total energy and by limiting the amount of data that is ultimately managed. That is, as noted, the system 101 is directed specifically at a localized community 200 in terms of its total energy behavior. Thus, a tailored management of its overall micro-grid, including multi-variant levels of optimization, are possible. Ultimately, this may result in a degree of efficiency for the grid which is heretofore unseen. In fact, this may even be achieved in a manner that does not require time-shifting energy constraints on end users in the community 200 or other similar energy sacrifices. Indeed, with efficiencies attained by such localized management, the system 101 may ultimately interface with the market 115 for sake of surplus energy sales.

Referring specifically now to FIG. 2, an overview schematic of the localized community 200 is shown with energy hardware infrastructure interfacing the management system 101 of FIG. 1. That is, the system 101 remains communicatively coupled to a market interface 115 and an external network 110, perhaps even ultimately reaching an external grid 275 as described further below. However, more notable is the communicative coupling between the system 101 and the local network 175 relative the hardware of the community 200, energy storage 222 and 262, and energy subsystem types 240, 260, 280 and 290. Thus, pertinent data and energy distribution may be discretely managed and tailored to the community 200.

Continuing with reference to FIG. 2, a distributed energy resource (DER) subsystem 290, and a primary energy storage subsystem 222 serve as the hard-line interface between the management system 101 and lines 245, 255, 265, 285 and 295 that supply energy to the community 200. For example, the community 200 may be made up of individual energy-drawing structures such as single-family dwellings 204, multi-family dwellings 203, high-rise buildings 202, office buildings 201, lighting 205 and perhaps industrial buildings or other relatively permanent or immobile fixtures. Thus, each of these structures may be equipped with at least one energy source provided which is in communication with the management system 101 through programmable logic controller (PLC) 250, sensors 252 and actuators 254 via network 175. More specifically, in the embodiment shown, lighting 205 is served by a single electric line 295 running from an electrical subsystem 222 and/or 290 that is coupled to the DER subsystem 290 for regulation and feedback. As a practical matter, multiple electrical DER subsystems 290 and primary energy storage subsystems 222 would likely be available to the community 200 in this manner so as to account for downtime, intentional or otherwise. Further, dwellings 201, 202, 203 and 204 may be served by the noted electric line 295 but also by way of separate heat 255, hydronic 265, syngas 245 and/or carbon dioxide 285 pipelines running from DER 290, hydronic 260, syngas 240, and carbon dioxide 280 subsystems, respectively. That is, as detailed further below, the community 200 may be served in a polygeneration fashion with multiple energy types available, even to the same power drawing structure. Regardless of type, each of the energy-generating subsystems 222, 240, 260, 280 and 290 may ultimately be controlled by the community-based, dedicated micro-grid management system 101 via individual PLCs 250. While electric power, industrial heat, syngas, hydronic energy, and carbon dioxide are described above, the micro-grid management system may regulate a variety of renewables including solar, wind, geothermal, hydro/hydraulic, biomass DER subsystem types, or alternatives including agricultural, industrial, municipal or otherwise waste-to-energy DER subsystem types.). That is, the overall micro-grid may be effectively optimized for polygenerational operations using multiple DERs and energy storage subsystems.

In one embodiment, mobile subsystems such as electric motor vehicles (e.g. electric motorcycles (not shown)) may be coupled to, and utilized with, the community system. That is, in addition to drawing power, such subsystems may also provide energy back to the community as needed. The collective sum of such vehicles may be thought of as constituting a unique type of storage subsystem. When not in motion, they may be plugged in so as to store energy from the micro-grid or for sake of releasing energy back to the micro-grid as noted. Further, in addition to motorcycles, scooters, tricycles, cars, vans, trucks, buses, wheelchairs and any other number of electrical vehicle types may be part of such a subsystem.

As indicated above, and with added reference to FIG. 1, the community 200 is localized in that its overall electric power needs may be more than adequately met by under 100 MW of power at any given point in time. As a result, the ability to employ optimizers 120, 122, 124, 126, 128 via the management system 101 is rendered a practical and effective endeavor due to the manageable amount of data exchange involved. With respect to the community 200 of FIG. 2, this means that optimization practical in a real-time sense and not merely a forecasting/predicting and/or estimating endeavor with reference solely to historical/empirical information and/or weather patterns.

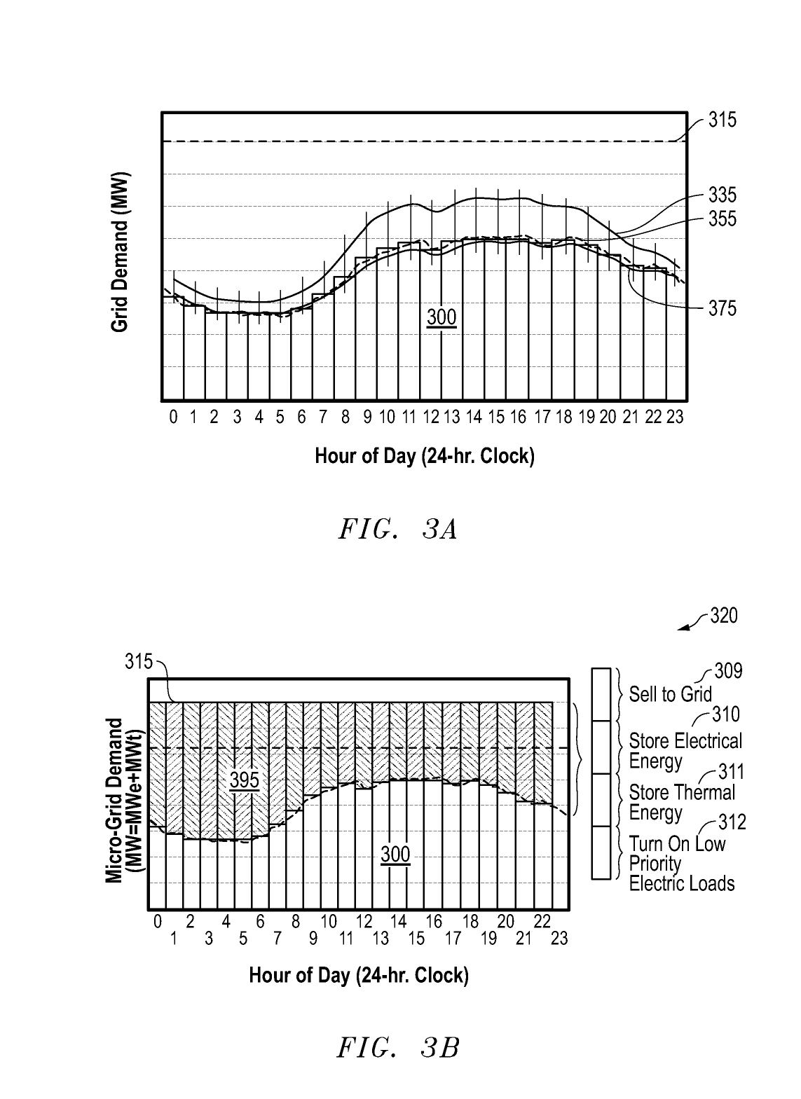

Once more, this also renders practical, the management of on-site energy storage. More specifically, a primary energy storage subsystem 222 and thermal energy storage subsystem 262 are depicted in FIG. 2 which include individual PLCs 250 for the communicative coupling between the system 101 and the local network 175. The particular type of storage may take a variety of forms. For example, the primary energy storage subsystem 222 may be based on mobile or stationary electrical-energy storage, molten salt thermal storage, mechanical-energy storage, pumped hydro/hydraulic-energy, chemical-energy storage or compressed gas energy storage that uses the excess energy capacity of the combined conventional grid and micro-grid system. In addition, the thermal energy storage subsystem 262 may be pressurized or non-pressurized subsystems that take the form of above ground or buried tanks, or horizontal or vertical pressure vessels that use excess energy capacity of the hydronic subsystem 260. That is, due to a micro-grid with a localized community focus, retaining and storing excess energy may now be a practical endeavor. This is in sharp contrast to a conventional large-scale conventional grid system for which not only is meaningful storage unlikely, most of the converted energy is lost to the biosphere almost immediately. This contrast is described in detail further below with reference to the charts of FIGS. 3A and 3B.

Returning to reference to FIG. 2, with excess storage capacity available, the primary energy storage subsystem 222 may be called upon for powering the community 200, for example, during periods of high usage. Note that a PLC 250 is coupled to each energy subsystem type 222, 240, 260, 280, 290. Alternatively, with the efficiencies of the micro-grid in mind, surplus energy may not be required for the community 200, converted into electric power and, thus, distributed or sold externally to the larger neighboring grid 210, for example, upon reaching predetermined price points. For example, note the physical and regulatory coupling of the DER 290 and the primary energy storage subsystem 222 to a grid interface 275, high voltage power lines 215, and grid 210.

Referring now to FIG. 3A, a graph is shown depicting a typical energy demand curve 300 as applied to the community 200 of FIG. 2. The vertical axis depicts electric power in units of megawatts (MWe). However, such a curve 300 may be roughly applicable to other communities as well. That said, FIG. 3B is provided to contrast the optimization benefits available from the micro-grid management system 101 of FIGS. 1 and 2 as applied to such a curve 300.

With specific reference to FIG. 3A, the grid may allocate the community 200 with a maximum capacity 315, for example, about 50-100 MW. However, actual demand 355 over the course of any given 24 hour period is unlikely to reach anywhere near such levels. Further, as shown in FIG. 3A, even in absence of a grid management system 101 as detailed hereinabove, certain management measures may be taken. For example, a record of the historical maximum demand 335 such that potential rises in actual demand 355 may be accounted for to a degree. Indeed, the noted operating capacity of the grid may be configured with such historical data in mind. Additionally, in the embodiment shown, smooth demand 375 data may be utilized for computations relative demand management. Thus, the overall amount of data may be managed in a more practical manner. So for this example, the amount of data managed hour to hour may be kept to a reasonable level for the grid operator.

With added reference now to FIG. 3B, the major difference in comparison to FIG. 3A is that the vertical axis depicts total energy in units of MW as the sum of both the MWe and thermal energy (MWt). FIG. 3B optimizations 320 may be applied to the micro-grid in light of the community's maximum capacity 315 and demand curve 300 as noted above. That is to say, for efficiency purposes the micro-grid may be operated at near maximum capacity on a continuous basis. More specifically, the graph of FIG. 3B reveals a 24-hour rolling cycle of operation that may continue on day after day. Thus, when examining the demand curve 300 it is apparent that at certain times of day, say at about 4 am for the 24 hour cycle depicted, the grid capacity far exceeds demand. On the other hand, at about 15:00 hours (3 pm), actual demand may come closer to system capacity 315. Stated another way though, in the embodiment shown, excess capacity 395 is available throughout the day (e.g. more at 4 am than at 3 pm).

With the above notion of excess capacity in mind, the indicated optimizations 320 may be taken advantage of. That is, as a practical matter, running the grid at near capacity 315 on a continuous basis is likely to be the most efficient mode of operations. For example, the subsystems 222, 240, 260, 280, 290 depicted in FIG. 2 are most likely to operate more efficiently on a continuous near-level basis as opposed to in an intermittent fashion. Of course, operating at near capacity in this manner means that excess capacity 395 will be generated on a near continuous basis as well. That said, to the degree that intermittency is permitted, it may be managed in an optimized fashion, ultimately via the system 101 as noted in FIG. 1 hereinabove.

Continuing with reference to FIG. 3B, unlike a conventional grid, one which employs a management system 101 as depicted in FIG. 1 with the available storage 222, 262 and other hardware of the community 200 of FIG. 2 avails itself of significant optimizations 320. More simply, the excess capacity 395 may be put to use as opposed to being predominately lost along large-scale power lines to distant locales or vented via heat energy transferred to the biosphere. Thus, running continuously at near capacity 315 means that excesses may be sold to an external grid 309 (see 210 of FIG. 2) or directed to low-priority electric loads 312. Once more, storage for later use 310, 311 may be a truly practical option given the on-site storage 222, 262 that are available for such a localized community 200 (again, see FIG. 2).

In contrast to a conventional large-scale grid system, the excess capacity 395 of the system depicted in FIG. 3B may be effectively taken advantage of due to its on-site localized nature. For example, while a conventional power plant system may experience about a 67% loss of the converted energy, the lack of significant transmission line loss combined with the practical ability for on-site storage means that such losses may be limited to no more than about 10% on average. Once more, while efforts are underway to limit or micromanage end-user power usage depending on the time of day, the micro-grid system of FIG. 3B faces no such limitations. That is, even where end users in the community 200 ramp up usage during the day (e.g. at 3 pm), such increased usage may be met by the micro-grid and supplemented with reliance on practical and readily available energy stores 222, 262. So for example, there is no need to exercise rolling blackouts due to renewable power intermittency (e.g. the wind stops blowing or the sun stops shining during peak demand periods). Thus, the individual end users need not wash dishes in the middle of the night (4 am) so as to conserve power available on the grid.

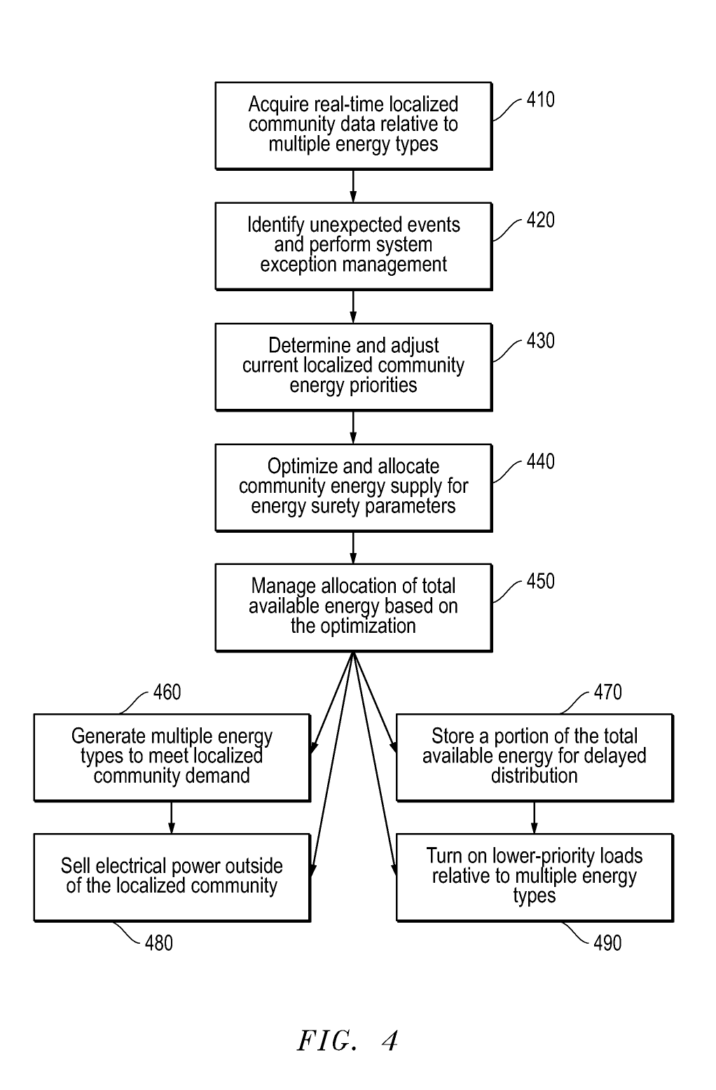

Referring now to FIG. 4, a flowchart is shown summarizing an embodiment of utilizing a community-based energy management system 101 as detailed herein. Namely, real-time actual-usage data relative multiple energy types for the localized community may be collected as indicated at 410. By analyzing that data, the management system 101 may quickly identify unexpected events or abnormal readings and perform the required exception management 420. With actual community 200 energy demand 300, the management system 101 may determine and adjust the energy priorities 430. This data may allow for the managed allocation of the total available energy to the community as indicated at 450 and in a manner that allows for its optimized distribution based on the community's energy surety objectives (see 440).

Once more, with such a localized grid and community focus, storage of excess energy as noted at 470 is rendered a practical and cost-effective endeavor. Thus, stores of energy (see 222, 262 of FIG. 2) may be made available for later use within the community (460) or for sales outside of the community (480).

Embodiments described hereinabove employ techniques for achieving substantial optimization of energy distribution across a community in ways that avoid many of the pitfalls of larger-scale power management. For example, increased safety and efficiencies are available whether measured in terms of cost-effectiveness, sustainability, or a host of other factors. This may include a micro-grid with varied distribution voltages. Further, inherent optimization limitations that are common with management of conventional large-scale grid data are avoided through use of techniques herein without sacrifice to overall system efficiency. Indeed, such efficiencies are even enhanced through use of the community-based energy management system techniques detailed hereinabove.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, energy-related data management as detailed hereinabove is focused on energy types and other overall system data points. However, these concepts may be extended to customer level feedback and optimization, for example, from dwelling to dwelling or even room to room therein. Thus, a variety of added levels of optimizations are readily available to the system in a practical manner given the localized community level amount of data involved. Regardless, the foregoing description should not be read as pertaining only to the precise structures described and shown in the accompanying drawings, but rather should be read as consistent with and as support for the following claims, which are to have their fullest and fairest scope.

I claim:

1. A method of managing energy surety in a localized community, the method comprising:
acquiring real-time community based data relative multiple energy types available from the localized community;
managing the allocation of the total available energy from the energy types, said managing including optimizing distribution of the total available energy based on the data; and
storing a portion of the total available energy for delayed distribution.

2. The method of claim 1 wherein the localized community is a community substantially serviceable by a power equivalent of no more than about 100 megawatts of electrical power.

3. The method of claim 1 wherein the real-time community based data is obtained from one of a micro-grid of the localized community, an immobile power drawing structure of the community and a room within the immobile power drawing structure.

4. The method of claim 1 wherein the delayed distribution is one of a distribution to within the community and a distribution transfer to an external grid.

5. The method of claim 4 wherein the distribution to within the community takes place at a time of comparatively high energy usage for the community.

6. The method of claim 4 wherein the distribution to an external grid takes place at a time of comparatively high energy cost to a customer of the external grid.

7. The method of claim 1 wherein said optimizing comprises enhancing one of energy security, energy safety, energy reliability, energy storage, energy sustainability, energy optimization and energy cost-effectiveness.

8. The method of claim 7 wherein said optimizing of security comprises monitoring breaches of one of physical security and cyber security across a micro-grid.

9. The method of claim 7 wherein said optimizing of safety comprises monitoring energy levels across a micro-grid.

10. The method of claim 7 wherein said optimizing of reliability and storage comprises managing energy intermittency and on-site energy storage.

11. The method of claim 7 wherein said optimizing of cost-effectiveness comprises managing one of energy sales to an external grid and managing waste of the community.

12. The method of claim 7 wherein said optimizing of sustainability and balance comprises managing a polygeneration of energy types.

13. The method of claim 12 wherein the energy types are selected from a group consisting of electrical, thermal, synthetic gas, carbon dioxide, renewable and alternative energy types.

14. The method of claim 1 wherein the total available energy is provided through a micro-grid of the localized community configured to operate at a near-maximum capacity on a substantially continuous basis.

15. The method of claim 14 wherein the near maximum capacity operating increases the total available energy for enhancing said storing.

16. An energy management system for a micro-grid of a community serviceable by an electric power equivalent of no more than about 100 megawatts, the system comprising:
a local area network of the community for providing real-time data relative total available energy from multiple energy types of the community; and
a network-based controller communicatively coupled to said network to acquire the data for optimizing distribution of the total available energy to the community, a portion of the distribution stored for delayed use.

17. The system of claim 16 wherein the optimizing includes enhancing at least one of a variety of static and dynamic optimizers relative the total available energy data, said controller configured to employ a fuzzy-logic envelope sequencing technique for the optimizing.

18. The system of claim 16 further comprising an energy manager coupled to said controller, said energy manager comprising:
a security monitor coupled to hardware of the micro-grid to monitor cyber and physical security thereof; and
a scheduler for managing one of pending transmission requests, preventative maintenance actions, and supply chain requirements.

19. A distributed energy micro-grid system for a community serviceable by a power equivalent of no more than about 100 megawatts of electrical power, the system comprising:
a plurality of immobile power drawing structures of the community;
at least one power storage subsystem of the community;
polygenerating power subsystems of the community to provide an energy total thereto, said subsystems having power lines running therefrom to said power drawing structures to provide a portion of the energy total thereto and to said power storage site to store a portion of the total available energy thereat; and
an energy management system with a controller to acquire real-time data relative the energy total from a local area network of the community, said energy management system configured to optimize distribution of the energy total between said structures and said storage site based on the data.

20. The system of claim 19 wherein said power subsystems include at least one subsystem selected from a group consisting of an electric power subsystem, a stationary energy storage subsystem, a mobile energy storage subsystem, a hydronic energy subsystem, a thermal energy storage subsystem, a synthetic gas energy subsystem, a carbon dioxide supply subsystem, a renewable energy power subsystem, and an alternative energy power subsystem.

21. The system of claim 19 wherein said energy management subsystem is configured to further optimize distribution relative a neighboring grid apart from the community.
